(19) United States
(12) Patent Application Publication
(10) Pub. No.: US 2022/0005082 A1
(43) Pub. Date: Jan. 6, 2022

(54) Public Good Coins

(71) Applicant: Gideon Samid, Rockville, MD (US)

(72) Inventor: Gideon Samid, Rockville, MD (US)

(21) Appl. No.: 17/478,953

(22) Filed: Sep. 19, 2021

Related U.S. Application Data
(63) Continuation-in-part of application No. 15/401,073, filed on Jan. 8, 2017, now abandoned.
(60) Provisional application No. 63/140,006, filed on Jan. 21, 2021.

(51) Int. Cl. G06Q 30/02; G06Q 20/06; G06Q 20/40; G06Q 20/32; G06Q 20/36

(52) U.S. Cl. CPC G06Q 30/0279; G06Q 20/065; G06Q 20/3678; G06Q 20/326; G06Q 20/327; G06Q 20/4016

(57) ABSTRACT

This invention describes an operation in which money is deposited in an interest-bearing account where the yield is serving a widely acceptable social goal, while digital claim checks for that money are transacted either digitally as a digital coin or through a physical contraption housing a memory device with the digital coin inside.

Continuation in Parts of U.S. patent application 15/401,073

### BRIEF SUMMARY OF THE INVENTION

This invention offers a mechanism to allow money to be deposited in an interest-bearing account, while claim checks for this same money are being traded by the public, serving the economy. The issued digital claim checks are redeemable at will, but their holders serve a public cause by not redeeming them, rather using them in lieu of money to be paid. Payees are incentivized by the same social cause to keep the claim check unredeemed. This invention further describes a physical embodiment of the claim checks, these embodiment acts like regular coins, transferrable from payor to payee.

### STATEMENT REGARDING FEDERALLY SPONSORED RESEARCH OR DEVELOPMENT: Not Applicable.

### REFERENCE TO SEQUENCE LISTING, A TABLE, OR A COMPUTER PROGRAM LISTING COMPACT DISK APPENDIX: Not Applicable.

### BACKGROUND OF THE INVENTION

The emerging technology of digital money opens up rich possibilities to impact the public to give generously to social causes of wide acceptance. This situation is further advanced by new technologies for secure hardware that can be used to house digital claim checks in contraptions similar to old fashioned coins thereby inviting people to trade with these contraptions on a basis of familiarity.

Snapshot: Describing an operation in which the public is incentivized to put money in a socially benefitting fund, against receipt of a digital claim check with which to reclaim the evolved value of the invested funds, such claim checks are optionally packed into a specially designed physical coin that trades in lieu of nominal payment. The technology of this physical coin resists fraud, and enables digital payment without real time network connectivity. The so called “Public Good Coin” (PGC) is minted in various denominations, and is attractive to display and use. In some setting the PGC functions just like cash because it can be redeemed for its face value at any moment—remotely. The operation and the coin technology are designed to create a strong incentive for the public to trade with the PGC rather than with nominal money, and as a consequence the money claimable by the PGC is working to generate funds dedicated to a universal social cause. The cause benefits, and the trading public benefits too because of the new payment routes offered by the PGC whether it is reduced to a physical coin or traded digitally without a physical embodiment.

### BRIEF EXPLANATION OF THE DRAWINGS

FIG. 1 Public Good Coin

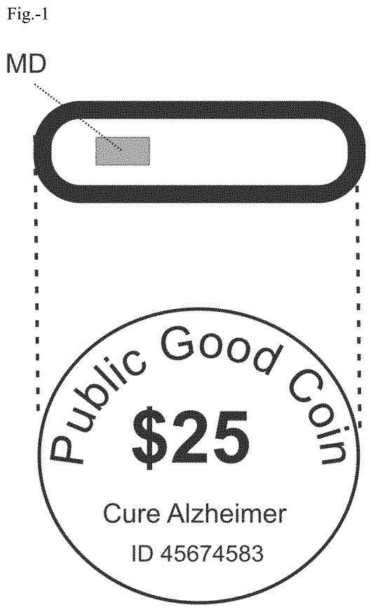

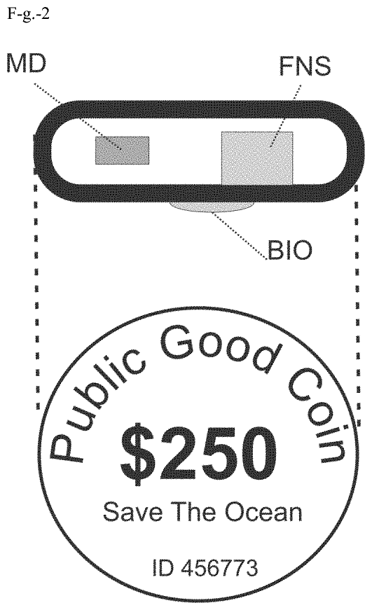

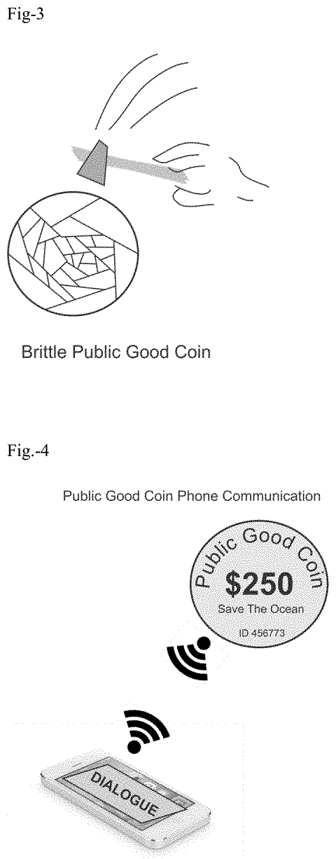

This figure depicts a low denomination public good coin. The value of the coin is clearly displayed. So is the cause it supports, and its unique ID. The manufacturing mint is also indicated but not shown. The coin is shown as circular, like regular coins but it could come with any shape variety and size variety. The upper part of the drawing shows the thick brittle material of construction of the coin, such that there is no feasible way to violate the integrity of the coin without making such violation patently clear to any potential payee of the coin. The figure shows the memory device, MD, where the digital coin housed in the public good physical coin is housed. This low denomination coin is assumed to belong to whoever has possession of it. Paying it to someone is very easy, simply handing it out.

FIG. 2 Public Good Coin (2)

This figure shows a high denomination public good coin. It displays it nature as ‘Public Good Coin’, it displays it par value $250,it displays the cause it supports “Save the Ocean”, and it shows its unique coin ID. The upper part of the drawing shows the memory device, MD where the digital data housed in the physical public good coin is housed. The figure also shows the fraud negation system, FNS, that is housed inside the coin and has the means to negate fraud attempts. The figure also show a BIO port, where the owner of the coin imprints a biological input, like a fingerprint.

FIG. 3 Brittle Public Good Coin

This figure shows a public good coin smashed by a light hammer. The coin breaks to small pieces, and exposed the memory device that can be pulled out and connected to a computing device to claim the value of the coin.

FIG. 4: Public Good Coin Phone Communication

This figure shows a high denominal public good coin communicating via Bluetooth with a phone, running a public good app, and activating a dialogue with the owner. The dialogue first requests the owner to imprint his or her fingerprint on the coin itself. The coin compares the imprint to its memory, and if validated then it accepts operation instructions given through the connected smart phone. Such instructions may be to prepare for smashing the coin, or to transfer coin ownership to a payee. The payee will then be asked to put their fingerprint for the public good coin to remember it as the new owner.

### INTRODUCTION

Most of the money distributed in society is at rest, not used. Its value is in its readiness to be used when and where needed, to pay for service, to influence people to do something you want done, to be given some merchandise. Because money at rest is useless, it makes sense for money owners to deposit their money in the bank, and hold a checking book allowing them to use the money when needed. But because most of the money in society is most of the time at rest, it is possible for the bank to take the risk and treat the deposited money as its own, giving it to those who need to use it, and who promise to return that money with interest. Part of this interest flows back to the original deposited, so all are participants are served.

This invention cast the same principle in an operation that allows society to generate funds dedicated to social causes that unify society as a whole. The idea is to allow a money owner to keep their money in a use-ready mode, while allowing the same money to be deposited in an interest-bearing account where many members of the public will also keep their pre-use money, and where the gain generated by this account will be dedicated to a cause that is appreciated by a large majority of the traders. While it is fair to say that the owner of the money could put that money in an interest-bearing account for their benefit, the reality is that everyone keeps some liquid money ready to use on the spot, without having first to pull funds from an interest bearing account. Such small ready-use amount are practically not earning any interest. However such small sums integrated over society at large will sum up to sizeable funds for the benefit of a universally acceptable social cause. Add to this the ability for members of society to consummate transactions by exchanging claim checks for the money deposited in the socially benefitting interest bearing account, then this will create a collection of money claim checks that replace money per se in various accounts. The said claim check is a digital statement that the money owner will present to the fund managers, claiming to be paid back the money they paid to the fund to generate interest for the social cause. These claim checks can be traded with the same effect and utility as the trade of money per so. This is so because the claim checks can be at any moment cashed in and be replaced by actual money.

This invention will come to strong effect through a public campaign encouraging people to pay and get paid with the claim checks, rather than with money per se. The argumenta will be (i) no loss: each claim check may be redeemed at face value at any time, and (ii) display of social responsibility and contribution—evident by use of the claim check. Such display will be more pronounced over the physical coins. A third advantage is that the new public good coins embody new technology that allows for direct trade like the old fashion cash, with no need for real time internet support.

This invention therefore concerns itself with (i) the operation for depositing and redeeming money for the socially benefitting fund, and (ii) an effective mechanism to promote active trade with the money claim checks instead of the money per so. This mechanism allows for digital trade per se, and for physical trade via physically built public good coins. In other words the trading mechanism described herein may be applied to digital coins per se.

Ahead we describe (i) the socially benefitting fund operation, (ii) digital trade, (iii) public good coins.

### The Socially Benefitting Fund

Let “Social Good Enterprise” be an organization dedicated to a universally accepted social goal. Such goal may be the cure of a bad common disease, combatting climate change, environmental objectives, world hunger, etc. We describe A Funding organization dedicated to raise funds to be given the Social Good enterprise.

The funding organization, (FO), will set up a fund FND. FND will be constituted in an investment state (IS), such that it will generate a gain, G. The G funds will be discounted by the

Fund organization, FO, to cover fees charged by the Fund organization, Fee. The balance B=G−Fee will be passed to the Social Good Enterprise.

Only the gain G will be removed from the fund.

The fund will be built from contributions of the public. A member of the public, m, will contribute an amount X to the fund. The Fund Organization will provide m with claim check, X_{claim-check}. That claim check can be used by m at agreed upon times to be exchanged against the value of X at the moment of redemption.

Let t=t₀ be the time the member of the public m contributed X to the FND. Let t=tᵣ be the time when m chose to redeem the claim check (X_{claim-check}). At tᵣ the value of X has become Xᵣ, which may be more or less than X, depending on the investment state of the fund. The member of the public, m, will then receive the amount Xᵣ against their claim check, X_{claim-check}.

Key to the operation of the fund is the situation where the fund will redeem the claim check to whomever submits it for redemption. Therefore m, is they find themselves in a situation where another member of the public, m′, is invoicing m for an amount Xᵣ then in lieu of paying money at the amount Xᵣ, m and m′ will be well disposed to pass the X_{claim-check} from m to m′.

The key to the success of this operation is that mutual incentive for m and m′ to consummate their pending truncation instead of through actual money transfer, to do so through claim check transfer. This mutual disposition will be achieved through the mutual knowledge of m and m′ that by replacing money transaction with claim check transaction they both make a personal contribution to the social cause they both support.

What happens between m and m′, will be repeated between m′ and m″ (a third member of the public). And so on. All that time, the money itself sits in the fund and generate gain to benefit the social cause.

For this operation to work it is necessary to implement a money claim check operation that will resist fraud. An optional way to do so is described in U.S. Pat. Nos. 8,229,859, 9,471,906, 11,107,156. The technology is herewith described in brief.

### Money Claim-Check Protocol

The fund organization, FO, will mint digital strings comprised of a payload and of claim check definition and attribution information (capsule), The capsule will identify the mint, and assign a unique identification to each claim check. The payload will be comprised of a string of bits where the {0,1} values of the bits has no impact on the value of the payload. The bits themselves per their position in the payload string carry the value of claim check according to specific value functions written into the capsule. This allows a claim check owner to divide their claim check of value X to two coins of values X′ and X″ such that X=X′+X″. This will be done by passing some bits of the payload to coin X′ and the rest of the payload bits will be written into X″. The identities of the payload bits will serve to assign identity to each coin.

This way of designing claim checks will allow a holder, m, of claim check X_{claim-check} to pay an amount X′<X to trader m′. Trader m will split their claim check X_{claim-check} to X^{′}_{claim-check} and X″_{claim-check}, hold on to X″_{claim-check} and pass X′_{claim-check} to m′.

Trader m′ will be able to further split X^{′}_{claim-check} to pay a third trader m″′ an amount X″′<X′ by splitting X^{′}_{claim-check} to X″′_{claim-check} to be passed to m″′ and keeping the balance X′_{claim-check}−X″′_{claim-check}.

Each holder of claim check which represents part or whole of the originally minted payload will be able to submit their claim check to the fund organization and redeem the matching funds.

Details of this technology are specified in patents U.S. Pat. Nos. 8,229,859, 11,107,156.

### Functional Elements

The public cause that is the object of the entire operation is represented by a publicly acclaimed organization dedicated to promote the cause. For example, public organization to combat cancer, diabetes, Alzheimer, or environmental clean-up the ocean or the forests. This organization will be given the funds raised from the yield of the fund.

The fund organization may work with a technology outfit to mint the digital claim checks and handle their redemption guarding against fraud. This technology outfit will operate a server to communicate with the public. Another technology outfit will manufacture the physical embodiment of the digital claim checks—the public good coins. The accumulating funds will be routed to a fund managed by an investment bank. The yields from the deposited funds will pay off the various entities associated with the fund organization for their contribution to the operation, and what is left will be routed to the publicly acclaimed organization supporting the declare public cause.

### Parallel Implementations

Several public causes may compete on the public money and can run in parallel. Recipients will be able to discriminate and say: we accept public good coins for defeating cancer, but we don't wish to be part of the anti climate change drive, etc.

### Baseline Fund Operation

As defined the money in the fund FND can be put in any investment state of choice, and redeemed according to any agreed upon terms. We now define a baseline operation where the investment state is risk-free interest bearing fund. Nothing in reality is “risk free” so the term will be clearly defined. The idea being that for all practical purposes Xᵣ=X. The redeemable value will be the par value of the investment in the fund. The social cause will benefit only from the interest generated by X for the period X is deposited in the fund, FND.

The redeeming time in the baseline mode will be ‘always’.

All this means that in the base mode a contributor to the fund can redeem the deposited funds at par, at any time. This fact serves as a strong incentive to a payee to accept X_{claim-check} in leiue of X. This incentive is augmented by the social benefit generated and the socially redeeming reputation gained by the payee.

### Digital Trade

Trade of digital claim checks for this public good operation will optionally be in adherence to the trade of digital coins specified in the following U.S. Pat. Nos. 8,229,859, 9,471,906, 11,107,156.

In brief, a recipient of a claim check X_{claim-check}, will real time validate with the fund organization whether this claim check is (i) valid, and (ii) has not been redeemed. If satisfied, the payee may request a new claim check X^{′}_{claim-check} for the same amount, X=X′, but with a unique set of identities to the bits of the payload. Claim check X_{claim-check} will be invalidated. The payee will be able to pass claim checks of values up to X to another payee, who will also validate the transaction online with the fund organization. The fund organization will keep a database with the images of status of the all the minted claim checks where each claim check will be identified as outstanding or redeemed. The fund organization will verify the validity of redeemed or validated claim check, as it whether it was issued (as identified by the identities of the payload bits) and whether it is still outstanding and was not yet redeemed.

### Public Good Coins

Digital claim checks in this operation will optionally be packaged into a physical coin comprised of a tamper-visible shell (TVS), coin operation logic (COL), and a memory device (MD) on which a digital claim check is written. In addition there will be memory device reader (MDR) which is a separate device from the public coin itself. The MDR will be able to be fitted with the memory device inside the coin, and be connected to a computing device so that the content of the memory device is transferrable to the computing device.

Ahead we describe (i) the operations carried out with the public good coin, and (ii) the detailed ingredients of the this coin, as well as (iii) the description of the MDR operation.

### Public Good Coin Operation

A member of the public m, decides to contribute an amount X to the fund, FND. The fund organization, FO, accepts X and adds it to the fund, then issues (mints) a digital claim check for the par amount X_{claim-check}.

The member of the public, m, can choose to get X_{claim-check} digitally to their computing device, or to receive the same packaged into a physical coin. This will be enabled only if X is one of the values for which the FO is prepared to mint a physical coin. There may be only a few accepted denominations, or many denominations, this is a decision of the FO.

Honoring the request of m the FO prepares a public good coin, marks it per its value X, and hands over the coin to m. Such handling over can happen hand to hand, or through the mail, as the case may be. m will be able to display the public good coin for other people to see and appreciate the social contribution it represents. The holder of the coin will also be able to pass it on to a second person to which the coin holder is indebted at the amount X or higher.

There are two passing modes, depending on the value of the coin. For low value coins the passing is simple straight forward, like passing a regular coin. The payee will examine the coin for physical integrity and for other signs of authenticity and decide to accept it as payment. The new holder will be able to pass it on to a third holder, and so indefinitely. The longer the public good coin is passed from one to the other, the longer the contributed money, at the amount X will be accumulating interest in favor of the universal social cause.

For high denomination public good coins the transaction will involve a high-security protocol to further alley the fear of the payee as to the bona fide of the transaction.

Sooner or later one holder of the coin will wish to redeem it. To do so, the coin holder will smash the coin's shell and pull out the memory device, MD. The holder will further fit the memory device within the memory device reader MDR, and through the MDR will pass the digital coin as written on the MD to the software issued by the fund organization (the FO application), where a pre encoded dialogue will guide the holder to send the digital coin to the fund organization and exercise the redemption protocol.

### The Parts of the Public-Good Coin

There are two classes of public good coins: basic security coin, and high-security coins.

The functional parts of the basic security coins are:
1.The tamper-visible shell (TVC) 2. The memory device (MD)

The functional parts of the high-security coins are:
1. The tamper-visible shell (TVC) 2. the memory device MD 3, Fraud negation system.

### The Tamper Visible Shell

Tamper visibility optionally will be achieved via application of the technology specified in U.S. Pat. No. 9,471,906. Other methods are valid too. The shell is constructed from a very brittle material that will crack into many tiny parts upon hammering at sufficient force (the amount of force needed to shatter the shell can be regulated by the shell builder). The shell will be wrapped around the MD and the system inside the coin fitted for fraud negation. There are no nails, nor screws, no way to reach the inside of the shell without shattering it to pieces. Therefore when a payee receiving the coin realizes that the physical integrity is in tact, their sense of confidence in the bona fide status of the coin is rising.

High security coins will be fitted with a bio reader. The bio reader will be designed to read finger print, or iris as the case may be.

In order to further incentivize people to use the public good coin, they will be designed in a variety of shapes and colors, so that there will be a pleasant impact to displaying them, hanging such coins on the wall, or using them as a present in lieu of writing a check. The external of the shell may be painted with bright colors with artistic rendition. The shape of the shell may also be of an artistic impact, commensurate with the denominated value.

The shell will display clearly the value of the coin, namely the value of the digital coin written into the memory device. The shell will identify the funding organization that mints it, and any other information of relevance.

As an accessory the traders of public good coins may purchase a shell cracker hammer, which is specially designed for size and weight to make it easy for a coin owner to crack the shell.

### The Memory Device

The memory device can be a simple micro SD which is readily read into a computing device. This may be the preferred solution for low denomination coins

### Fraud Negation System

Small denomination public good coins are protected from fraud through their tamper-visibility shell (TVS). Any tampering is readily visible. If the coin shows physical integrity it is being trusted.

High denomination public good coins will optionally be protected with a bio-ownership system that insures that only the rightful owner can (i) redeem the coin, and (ii) transfer the coin to a new owner. Another option is a personal key entered either directly through a small numeric pad, or through a connecting app on a smart phone. This means will discourage theft.

The coin FNS will be operated via a dedicated long lasting battery.

### Insuring Redemption by Rightful Owner

The rightful owner of public good coin upon deciding to redeem the digital coin in the physical coin, or upon a decision to use the digital coin online as a regular coin, will have to crack the tamper visibility shell, and remove from the physical coin the memory device where the digital coin is written and pass this coin through the memory device reader to a computing device possibly loaded with the fund organization application, and pass the digital coin to the fund organization, FO, for redemption.

The physical coin will be fitted with a computerized capability that would communicate with the owner on the right procedure to insure smooth redemption.

This safe redemption procedure may be based either on identification code, or bio information. In either case the owner has identified themselves to the built in fraud negation software. Before cracking the shell the rightful owner will have to ‘talk’ to the coin through the selected human-machine communication system. The owner will tell the coin that they plan to crack the shell. The coin will respond by saying to the owner: enter your owner id, and respond to question validating an re-validating that the owner intends to break the shell. Once the validation is entered, the coin fraud negation software (FNS) will indicate to the owner that they have a prescribed limited time (e.g. 60 seconds) to crack the coin. The owner will do so, and retrieve the memory device containing the digital coin. If the shell is cracked without prior exercising the above mentioned dialogue then the coin fraud negation software will activate a content erasure subsystem that would wipe out the contents of the memory device before the shell cracker can read it.

The coin fraud negation software will have one or more of the cracking detection mechanisms to be used as a means of spotting a shell cracking situation that has not been previously verified with the above mentioned dialogue. The coin FNS will use any of the means mentioned in U.S. Pat. No. 9,471,906. In most cases a light detector will be sufficient. The inside of the public good coin is dark, upon cracking it, light comes in and activates the memory erasure subsystem. In addition a noise activator, a pressure activator, and a content activator may be used. Optional technology is specified in the above mentioned US patent.

This mechanism will insure that the rightful owner will have an easy way to crack the shell and pull out the digital coin, while a thief will be frustrated. This works as a string disincentive for fraud.

### Human-Coin Communication System

This system is only present in high denomination public good coins. It will be either fitted into the back of the coin comprising an id-input element, a binary signaling key, and a small optionally monochromatic digital display strip. These elements will be used to exercise the anti fraud dialogue mentioned above.

A more convenient way will be to have the coin communicate via Bluetooth or NFC with a telephone app that will display on the telephone screen the messages of the coin as in the above mentioned dialog and will take in the owner responses, and pass them to the coin through the same communication channel.

Owner ID can be set as digital key comprising alphanumeric characters of sufficient length, at least 4, better 6, or more. If the communication human-coin is through the phone then the owner id will be full alpha numeric. If it is a small entry port on the coin itself then the id code will be numeric only, to make it possible to put only 10 buttons on the coin itself. Not to overload it.

For a bio id, say a finger print, the coin will be fitted with a fingerprint reader and related circuitry.

The operation of the coin will be such that the virgin coin just manufactured and issued by the fund organization, FO, will be awaiting to receive the id data of its owner. Once entered, the coin remembers this id, and will obey only command of anyone who can prove their identity with the pre stored id.

Optionally the coin id will be comprised of both an alphanumeric id and a bio-id. The combination may be designed to be either or. Namely the coin takes orders only if both the digital id and the bio id are properly entered, or the coin can be designed to obey orders if only one of the two id types is properly entered.

### Safe Transfer from One Holder to the Next

Small denomination coins will have no special protocol to pass ownership. They will work as ordinary coins, passed from hand to hand.

High denomination public good coins will allow ownership transfer via the following protocol between payer and payee.

One starts with the situation where the payer has its owner id entered into the coin (whether a code or a bio entry).

To pass the coin to the payee, the payer will activate the human-coin communication system, and will signal to the coin their wish to transfer ownership of the coin.

The coin will then ask “Are you sure you wish to pass the coin to a payee?” (or similar wording). The owner will reply “yes”. Then the coin fraud negation software will instruct the owner to enter their owner id (whether an alphanumeric code, or the bio id). Once the coin FNS reads properly the id and verifies it with its stored id, it instructs the owner to ask the payee, the prospective new owner, to enter its personal id. If it is an alphanumeric code then the new owner (the payee) will be asked to enter a choice of the right number of characters. It will be up to the payee to enter an alphanumeric code that they will remember to handle the coin afterwards. If that id is forgotten or lost, the coin cannot be operated. It is nominally lost, except for some prospective elaborate rescue operation discussed elsewhere.

If the payee id is in the form of a bio id then upon instruction the payee will put in their bio id. If the bio id is a fingerprint then the coin FNS will ask the payee if they wish to put in the fingerprint of another finger, and then another, until the payee is satisfied. Normally a single fingerprint will do.

Once the payee enters their new owner id, they become the controller of the coin for redemption and for passing it to a third trader. The coin NFS will forget the id of the previous owner. This communication between the public good coin and a payer and a payee is carried out with local touch communication and local human-coin communication only. No network no Internet is involved. The FO is not aware of such transactions, and in general the fund organization does not know who hold any given coin at any moment.

This ownership transfer protocol rebuffs a thief who may have stolen public good coin, but is unable to pass it as payment to anyone else because the thief is not the registered current owner of the coin. As we have seen the thief also cannot redeem the stolen coin.

This solution to passing ownership of coins can be adopted over regular digital coin, not limited to public good coins.

### The FNS Battery

The battery to operate the FNS may be fitted with a charging port to allow a DC charge, like a phone. However for better security the coin will be fitted with long lasting battery that cannot be replaced. The battery burden is quite limited. It is activated only when the coin is paid, or when it is to be redeemed. However the coin will be alerting its owner when its charge is almost drained. The owner will then hurry to redeem the coin. The coin may be programmed to erase its contents (the digital coin inside) as the last action before losing power completely. Whether this would be the active option or not will be decided as part of setting the preference by the owner.

Once the battery inside the coin dies, the owner will have a recourse to bring it back to the fund organization asking to redeem it. The FO will have a record of that coin ID, will verify that the digital coin inside the public good coin was not redeemed previously, and might at its own discretion redeem it for its par value. For precaution the FO might insist on registering the identity of the redeemer, in case some difficulties arise later.

### Public Good ‘Banknotes’

Much as metal coins are joined with paper banknotes, so the public good coins can be accompanied by document based carriers of fraud-resistant digital money claim checks: public good banknotes. This can be done using the technology specified in the referenced provisional application 63/140,006.The transaction protocol for these ‘banknotes’ is different than for the public good coins. The transfer will require a dedicated document validation device that will compare features of the banknote with stored features of the issued banknote. Much like the public good coin, these public good banknotes will be printed with the par value of the note, with identification of the cause it supports, the issuing authority, expiration date if any, and the banknote id.

Application Extension: Both the public good coins and the public good banknotes may be used to effect direct payment of digital coins of various kinds.

This invention describes a method to combine public trust, public cause, and digital transaction technology to achieve a parallel use of money wherein currency is participating in payment dynamics while at the very same time interval, same currency is accumulating interest; the interest is accumulating in favor of a public cause, which in turn motivates the public to trade not with the currency itself, but with redeemable digital claim checks for the same; the trust for instant redemption of the digital money claim checks together with the public service of the accumulated interest transforms the traded digital money claim checks to acceptable payment, and thereby achieving the double use of money: (i) to serve a public cause through accumulated interest, and (ii) to serve as an instant, always-on, redemption reserve for any circulating digital money claim check;

involving

(i) a digital money claim checks mint,

(ii) a financial investment institution,

(iii) a widely acceptable public cause, and

(iv) always-on digital money technology;
wherein the always-on digital money technology renders a digital money claim check to be equivalent for payment purposes to the currency itself on account of its holder being able to turn the digital money claim check to its denominated currency anywhere, anytime, without delay; this functional equivalence between the digital money claim check and the money itself when combined with the public awareness that by trading with digital money claim checks rather than with money per se they act charitably in as much as the not yet redeemed money is accumulating interest for the widely acceptable public cause, tilts the functional equivalence towards preferring digital money claim checks over per se money, and thereby operating a durable manifestation of this parallel use of money; the technology that enables this always-on, anywhere, anytime instantly redeemable digital money claim checks is embodied in an arrangement wherein a server

(i) has access to a database that holds images of the minted digital money claim checks, and

(ii) is accessible from any Internet-connected computing device that stores the digital claim check, and where the security and the integrity of the digital money claim check is maintained via instant refreshment of any claim check which may take place anytime, anywhere, and without delay; where a refreshment is a replacement of a claim check received by a payee with a freshly minted claim check for the same par value; the digital money claim check mint being a financial server accepting money deposited from the public, minting a digital money claim check for the amount of money deposited, passing the digital money claim check to the depositor; the depositor using the digital money claim check in lieu of money, for any payment; the recipient of the digital money claim check will refresh it, namely exchange the received digital money claim check with another digital money claim check minted for them in the digital money claim check mint, and then pass the fresh digital money claim check to a third trader in lieu of payment of money per se, wherein the third trader will repeat the procedure, so that the digital money claim check traverses from one money trader to another until a current holder of the digital money claim check is submitting it to the digital money claim check mint for redemption against the money deposited by the trader that paid money for the digital money claim check, and where the money deposited by the trading public is passed to a financial investment institution where these deposits accumulate into a risk-free, interest-bearing fund, where the accumulated interest is transmitted to a public institution promoting the widely acceptable public cause.

This method is further characterized by having the digital money claim checks be split by their holder so that any part of their denominated value is passed to a recipient, while the balance remains in the possession of the transmitter of the digital money claim check, such that the value of the transmitted digital money claim check plus the value of the digital money claim check left in the possession of the transmitter equals the value of the pre-split claim check; and where such splitting is iterative, namely a split digital money claim check can be split again; this digital money claim check splitting capability puts the claim check into an operational equivalence with nominal forms of digital money.

Furthermore the split of the digital money claim check is accomplished between digital money claim check transmitter and digital money claim check recipient directly, from one personal computing device to another, without having to engage the digital money claim check mint.

One optional way to implement the digital claim checks is through direct transmission between the digital money claim check transmitter and the digital money claim check recipient. It is carried out by expressing the value of the digital money claim check by the bit count of a digital money claim check bit string wherein the {0,1} identities if the bits in the digital money claim check string are used to distinguish this string from any other minted string of similar bit count, and whereby the split of the digital money claim check is done by splitting the digital money claim check string to two sub strings, wherein the value of each sub string is expressed by its bit count.

The digital claim checks may be implemented via a physical embodiment wherein the digital claim checks are fitted into a physical enclosure on which the value of the digital claim check is marked, this physical enclosure is regarded as public-good coin. Its holder will pay the marked amount by handing over the public good coin to a payee; in this physical embodiment the digital claim check may be passed around within the community of traders, acting like cash, while the money that was used to purchase it is concurrently invested in a fund that generates a yield towards a widely accepted public cause.

This invention also described a system to effect direct payment of digital claim checks without having to establish contact with a remote server, comprising a device regarded as a public good coin, comprising a tamper-visibility shell, in which there is a memory device on which a digital claim check for a specified amount of money is being written, and where the public good coin is also marked with a coin id; and where any current holder of the public good coin can redeem the amount of money specified by the digital claim check by:

(i) applying a light hammer, or an equivalent tool, to the tamper-visibility shell (TVS), thereby shattering the shell to many little pieces on account of the shell being constructed from a very brittle material, then

(ii) removing the memory device from the inside of the public good coin, and (iii) attaching the memory device via a memory device reader to a personal computing device on which an dedicated application is being run, so that the dedicated application reads the digital claim check from the memory device and passes it to a remote server that handles the redemption of the digital claim checks, where the digital claim check is being validated and, if validated, the redeemer is paid the par value of the claim check.

The public-good coin system may be implemented such that the public good coin also includes a fraud negation system, FNS, comprising a dedicated computing unit, and a long lasting battery to operate it, where the FNS is running an ownership assertion protocol in which the holder of the public good coin is asked to provide an identity mark, and wherein the identity mark is stored inside the FNS, and from that moment on, any communication to the public good coin is validated by the communication source having to validate their identity by providing their identity mark, where the FNS compares the entered identity mark to the stored identity mark, and the FNS only abides by the communication to it if the entered identity mark matches the pre stored identity mark.

Optionally the system will be implemented such that the communication between the public good coin holder and the public good coin is carried out through Bluetooth communication established between the public good coin and a smart phone running a dedicated application.

One optional identity marks is wherein the identity mark is in a form of an alphanumeric sequence of specified number of characters; the characters are entered either via a smart phone linked with the public good coin, or via a small numeric pad fitted on the back of the public good coin.

Another optional identity mark is wherein the identity mark is a bio-marker, like a fingerprint, entered via a fingerprint port fitted at the back of the public good coin.

The FNS will run an owner transfer protocol as follows:

(i) The current owner (the payor) is indicating to the public good coin (the FNS) their intent to transfer ownership.

(ii) The public good coin instructs the payor to validate themselves by entering the identity mark,

(iii) The payor enters their identity mark,

(iv) The public good coin validates the payor based on the stored identity mark of the public good coin owner.

(v) The public good coin instructs the payor to instruct the payee to enter their identity mark to the public good coin,

(vi) The payee enters their identity mark

(vii) The public good coin stores the identity mark of the payee and erases the identity mark of the payor.

From that moment on the public good coin obeys only the orders of the payee.

This procedure (i) (vii) will apply when the payee wishes to become a payor and transfer ownership to a third person.

Redemption: the FNS is running a coin-hammering protocol as follows:

(i) the owner of the public good coin is indicating to the public good coin (the FNS) their intent to hammer the coin (break it up) in order to retrieve the memory device and the digital coin written on it.

(ii) the FNS instructs the owner to enter their identity mark.

(iii) the public good coin owner enters their identity mark,

(iv) the FNS validates the entered identity mark by comparing it to the stored identity mark; if the validation fails the protocol is aborted, if the validation succeeds then:

(v) the FNS instructs the owner that they have a specified short time (e.g. 60 seconds) to hammer the public good coin and retrieve the memory device inside.

(vi) the owner hammers the public good coin within the specified time interval and retrieves the memory device;

if the public good coin is hammered and broken without the activating the dialogue (i)-(vi) then:

(a) the breakup of the coin is detected by a subsystem of the FNS which is integrity-violation detection system (IVDS), where the IVDS is triggered by various side effects of a break up of the public good coins, among them are light detection, noise detection, and pressure changes for cases where the inside of the public good coin is kept in either some measure of vacuum or an above atmospheric pressure, and where upon being triggered the IVDS activates another subsystem of the FNS—the memory-erasure subsystem, which erases the memory of the memory device.

A fraudster might steal a public good coin, then wait for its battery to die before he breaks it up. This will be prevented as follows: in the event that the battery is close to empty, the public good coin activates a battery-alarm subsystem (BAS) inside the FNS, and the BAS issues a battery alarm for the attention of the public good coin owner; the public good coin owner will then activates the coin break up protocol to retrieve the memory device before the battery is exhausted; if the public good coin break up protocol is not being activated then before the battery is empty it erases the content of the memory device.

Alarm option: the battery alarm subsystem issues a periodic audible sound to alert the public good coin owner.

Alternatively the battery alarm subsystem sends a message to phone used by the public good coin owner in prior communication dialogue with the public good coin.

Expiration Date: Optionally the public good coin are marked with an expiration date, following which the only way to redeem the public good coin is to bring the public good coins physically to the issuing authority.

What is claimed is:

1. A method to combine public trust, public cause, and digital transaction technology to achieve a parallel use of money wherein currency is participating in payment dynamics while at the very same time interval, same currency is accumulating interest; the interest is accumulating in favor of a public cause, which in turn motivates the public to trade not with the currency itself, but with redeemable digital claim checks for the same; the trust for instant redemption of the digital money claim checks together with the public service of the accumulated interest transforms the traded digital money claim checks to acceptable payment, and thereby achieving the double use of money: (i) to serve a public cause through accumulated interest, and (ii) to serve as an instant, always-on, redemption reserve for any circulating digital money claim check;
involving
a digital money claim checks mint,
(ii) a financial investment institution,
(iii) a widely acceptable public cause, and
(iv) always-on digital money technology;
wherein the always-on digital money technology renders a digital money claim check to be equivalent for payment purposes to the currency itself on account of its holder being able to turn the digital money claim check to its denominated currency anywhere, anytime, without delay;
this functional equivalence between the digital money claim check and the money itself when combined with the public awareness that by trading with digital money claim checks rather than with money per se they act charitably in as much as the not yet redeemed money is accumulating interest for the widely acceptable public cause, tilts the functional equivalence towards preferring digital money claim checks over per se money, and thereby operating a durable manifestation of this parallel use of money;
the technology that enables this always-on, anywhere, anytime instantly redeemable digital money claim checks is embodied in an arrangement wherein a server
(i) has access to a database that holds images of the minted digital money claim checks, and
(ii) is accessible from any Internet-connected computing device that stores the digital claim check, and where the security and the integrity of the digital money claim check is maintained via instant refreshment of any claim check which may take place anytime, anywhere, and without delay; where a refreshment is a replacement of a claim check received by a payee with a freshly minted claim check for the same par value;
the digital money claim check mint being a financial server accepting money deposited from the public, minting a digital money claim check for the amount of money deposited, passing the digital money claim check to the depositor; the depositor using the digital money claim check in lieu of money, for any payment; the recipient of the digital money claim check will refresh it, namely exchange the received digital money claim check with another digital money claim check minted for them in the digital money claim check mint, and then pass the fresh digital money claim check to a third trader in lieu of payment of money per se, wherein the third trader will repeat the procedure, so that the digital money claim check traverses from one money trader to another until a current holder of the digital money claim check is submitting it to the digital money claim check mint for redemption against the money deposited by the trader that paid money for the digital money claim check,
and where the money deposited by the trading public is passed to a financial investment institution where these deposits accumulate into a risk-free, interest-bearing fund, where the accumulated interest is transmitted to a public institution promoting the widely acceptable public cause.

2. The method of claim 1 wherein the digital money claim checks can be split by their holder so that any part of their denominated value is passed to a recipient, while the balance remains in the possession of the transmitter of the digital money claim check, such that the value of the transmitted digital money claim check plus the value of the digital money claim check left in the possession of the transmitter equals the value of the pre-split claim check;
and where such splitting is iterative, namely a split digital money claim check can be split again;
this digital money claim check splitting capability puts the claim check into an operational equivalence with nominal forms of digital money.

3. The method of claim 1 wherein the split of the digital money claim check is accomplished between digital money claim check transmitter and digital money claim check recipient directly, from one personal computing device to another, without having to engage the digital money claim check mint.

4. The method of claim 1 wherein the direct transmission between the digital money claim check transmitter and the digital money claim check recipient is carried out by expressing the value of the digital money claim check by the bit count of a digital money claim check bit string wherein the {0,1} identities if the bits in the digital money claim check string are used to distinguish this string from any other minted string of similar bit count, and whereby the split of the digital money claim check is done by splitting the digital money claim check string to two sub strings, wherein the value of each substring is expressed by its bit count.

5. The method of claim 1 wherein the digital claim checks are fitted into a physical enclosure on which the value of the digital claim check is marked, this physical enclosure is regarded as public-good coin. Its holder will pay the marked amount by handing over the public good coin to a payee; in this physical embodiment the digital claim check may be passed around within the community of traders, acting like cash, while the money that was used to purchase it is concurrently invested in a fund that generates a yield towards a widely accepted public cause.

6. A system to effect direct payment of digital claim checks without having to establish contact with a remote server, comprising a device regarded as a public good coin, comprising a tamper-visibility shell, (TVS), in which there is a memory device on which a digital claim check for a specified amount of money is being written, and where the public good coin is also marked with a coin id; and where any current holder of the public good coin can redeem the amount of money specified by the digital claim check by:
(i) applying a light hammer, or an equivalent tool, to the tamper-visibility shell (TVS), thereby shattering the shell to many little pieces on account of the shell being constructed from a very brittle material, then
(ii) removing the memory device from the inside of the public good coin, and
(iii) attaching the memory device via a memory device reader to a personal computing device on which a dedicated application is being run, so that the dedicated application reads the digital claim check from the memory device and passes it to a remote server that handles the redemption of the digital claim checks, where the digital claim check is being validated and, if validated, the redeemer is paid the par value of the claim check.

7. The system in claim 6 wherein the public good coin also includes a fraud negation system, FNS, comprising a dedicated computing unit, a communication channel with the public good coin owner, and a long lasting battery to operate it, where the FNS is running an ownership assertion protocol in which the first holder of the public good coin is asked via the communication channel to provide an owner identity mark, and wherein the owner identity mark is stored inside the FNS, and from that moment on, any communication to the public good coin is validated by the public good coin owner having to validate their identity by providing their identity mark, wherein the FNS compares the entered identity mark to the stored identity mark, and the FNS only abides by the communication to it if the entered identity mark matches the pre stored identity mark.

8. The system in claim 7 wherein the communication between the public good coin holder and the public good coin is carried out through Bluetooth communication established between the public good coin and a smart phone running a dedicated application.

9. The system in claim 7 wherein the identity mark is in a form of an alphanumeric sequence of specified number of characters; the characters are entered either via a smart phone linked with the public good coin, or via a small numeric pad fitted on the back of the public good coin.

10. The system in claim 7 wherein the identity mark is a bio-marker, like a fingerprint, entered via a fingerprint port fitted at the back of the public good coin.

11. The system in claim 7 wherein the FNS runs an owner transfer protocol as follows:
(i) the current owner (the payor) is indicating to the public good coin (the FNS) their intent to transfer ownership,
(ii) the public good coin instructs the payor to validate themselves by entering their identity mark,
(iii) the payor enters their identity mark,
(iv) the public good coin validates the payor based on the stored identity mark of the public good coin owner,
(v) the public good coin instructs the payor to instruct the payee to enter their identity mark to the public good coin,
(vi) the payee enters their identity mark,
(vii) the public good coin stores the identity mark of the payee and erases the identity mark of the payor, from that moment on the public good coin obeys only the orders of the payee;
this procedure (i)-(vii) will apply when the payee wishes to become a payor and transfer ownership to a third person.

12. The system in claim 7 wherein the FNS is running a coin-hammering protocol as follows:
(i) the owner of the public good coin is indicating to the public good coin (the FNS) their intent to hammer the coin (break it up) in order to retrieve the memory device and the digital coin written on it;
(ii) the FNS instructs the owner to enter their identity mark;
(iii) the public good coin owner enters their identity mark;
(iv) the FNS validates the entered identity mark by comparing it to the stored identity mark; if the validation fails the protocol is aborted, if the validation succeeds then:
(v) the FNS instructs the owner that they have a specified short time (e.g. 60 seconds) to hammer and break the public good coin and retrieve the memory device inside;
(vi) the owner hammers the public good coin within the specified time interval and retrieves the memory device;
if the public good coin is hammered and broken without the activating the dialogue (i)-(vi) then: (a) the breakup of the coin is detected by a subsystem of the FNS which is an integrity-violation detection system (IVDS), where the IVDS is triggered by various side effects of a break up of the public good coin, among them are light detection, noise detection, and pressure changes for cases where the inside of the public good coin is kept in either some measure of vacuum or an above atmospheric pressure, and where upon being triggered the IVDS activates another subsystem of the FNS—the memory-erasure subsystem, which erases the memory of the memory device.

13. The system in claim 7 wherein in the time comes when the battery is close to empty, the public good coin activates a battery-alarm subsystem (BAS) inside the FNS, and the BAS issues a battery alarm for the attention of the public good coin owner; the public good coin owner will then activate the coin break up protocol to retrieve the memory device before the battery is exhausted; if the public good coin break up protocol is not being activated then before the battery is empty it erases the content of the memory device.

14. The system in claim 13, where the battery alarm subsystem issues a periodic audible sound to alert the public good coin owner.

15. The system is claim 13, where the battery alarm subsystem sends a message to the phone used by the public good coin owner in prior communication dialogue with the public good coin.

16. The system in claim 7 where the public good coin is marked with an expiration date, following which the only way to redeem the public good coin is to bring the public good coins physically to the issuing authority.
